(19) United States
(12) Patent Application Publication
(10) Pub. No.: US 2015/0158409 A1
(43) Pub. Date: Jun. 11, 2015

(54) Drill Cuttings Tank Having Dual Auger Units

(71) Applicant: Environmental Drilling Solutions, LLC, Lafayette, LA (US)

(72) Inventors: Chad Hollier, Lafayette, LA (US); Jake Garber, Lafayette, LA (US)

(21) Appl. No.: 14/103,374

(22) Filed: Dec. 11, 2013

(51) Int. Cl. B60P 1/42

(52) U.S. Cl. CPC B60P 1/42

(57) ABSTRACT

A mobile drill cuttings tank system includes a cuttings tank having a pair of rotatable feed augers positioned in troughs running the length of the tank. Cuttings from the shale shaker on a drilling rig fall into the tank. Each feed auger is coupled to an independent drive unit, such as a variable frequency drive electric motor, so that each feed auger may be independently rotated at a desired speed and direction. The feed augers move cuttings to one end of the tank, where they fall through a transition piece and are picked up by boom augers which rotate within dual booms which extend away from the tank. The booms/boom augers move the cuttings to additional processing equipment, such as a cuttings drying unit. The cuttings tank has a wheel assembly so that it may be pulled by a tractor on a roadway.

### CROSS REFERENCE TO RELATED APPLICATIONS

Not applicable.

### BACKGROUND

### Field of the Invention

This invention relates to apparatus for receiving drill cuttings from the shale shaker of a drilling rig into a tank, and transferring the cuttings from the tank to further drill cuttings processing equipment, for example a cuttings drying unit, typically a centrifugal cuttings drying unit, drying shakers, or trucks for haul off to a disposal pit, or some other disposal. Prior systems/methods generally required a bucket scoop to scoop cuttings from the cuttings tank (positioned below the shale shaker) and move them to a feed tank, and from there to the inlet of the centrifugal unit or other cuttings processing equipment or truck for disposal.

### SUMMARY OF THE INVENTION

The drill cuttings tank with dual auger units, of the present invention, comprises an elongated, open top tank having dual feed augers running substantially the length of the tank, disposed in separate troughs in the bottom of the tank. A raised section or low wall separates the troughs over most of their length. A first end of the tank has a wheel assembly so that the tank may be attached to a tractor and transported on a roadway. The feed augers may be independently rotated, preferably by variable speed electric drives (commonly known as variable frequency drive or VFD) which permit control over both the speed of rotation and direction of rotation of each feed auger independently of the other. Preferably, at least one of the feed augers has a longitudinal paddle member fixed near one end, which permits cuttings to be moved from one feed auger transversely over to the other feed auger. The feed augers are suspended in the troughs by a hanger and split bearing assembly which connect to cross pieces which span the troughs, and which permit vertical adjustment of the feed augers. The feed augers are preferably made in multiple pieces or sections, each rotationally locked to the next, to enable easy removal of the feed augers from the tank for repair and replacement. The split bearings permit removal of the bearings without having to slide them the entire length of a feed auger. A pair of transition pieces are mounted by flanges to the tank, and cuttings from the feed augers go into a receiving chamber in the transition pieces.

Dual booms, each having a powered boom auger therein, stab into the transition pieces and connect to them by flanges, and receive the cuttings as moved by the feed augers. The boom and auger can be readily removed from the transition piece, the transition piece disconnected from the tank and moved to a new desired position and orientation with respect to the tank, re-connected to the tank, then the boom and auger stabbed back into the transition piece.

Preferably, the bottom of the tank slopes upward from the first end to a second end, so as to provide vertical clearance for the booms and transition pieces. Handrails on top of the tank may be rotated to a flat position for transit. Saddle members placed atop the tank provide a location for storage of the booms when the unit is in transit.

### BRIEF DESCRIPTION OF THE DRAWINGS

FIG. 1 is a top view of an exemplary dual auger tank system of the present invention.

FIG. 2 is a side view of the dual auger tank system of FIG. 1.

FIGS. 3 and 4 are side and top perspective views of the auger tank system, as attached to a tractor for road transport.

FIG. 5 is a section view, showing certain detail of the dual feed augers within the tank.

FIG. 6 is another section view, showing additional detail of the dual feed augers within the tank, including the feed auger hanger and split bearing assembly.

FIG. 7 is a detailed perspective view of one end of the dual feed augers positioned within the tank.

FIG. 8 is a view of the transition piece showing a boom and boom auger inserted therein.

FIG. 8A is a side view of the transition piece alone.

FIG. 9 is a detailed view illustrating removal of a section of the multi-piece auger.

FIG. 10 is a cross section view of one embodiment of a connector between auger sections.

### DESCRIPTION OF THE PRESENTLY PREFERRED EMBODIMENT(S)

While various configurations of dual auger tanks can embody certain principles of the present invention, with reference to the drawings some of the presently preferred embodiments can be described.

In summary, the invention is a mobile (via public roadways, pulled by an 18-wheeler type “tractor”) cuttings tank, preferably having at least two feed augers rotatably disposed in troughs in the bottom of the tank. The tank has a wheel assembly on a first end, such that the tank can be connected to a tractor for roadway transportation. The feed augers can be independently rotated, as to both direction and speed (of rotation). Typically, this is done via multiple variable frequency drives (one on each feed auger). Each feed auger moves cuttings to a transition piece connected to the tank. From there, the cuttings are fed to one of a pair of driven augers within booms, which extend upwardly away from the cuttings tank and move the cuttings to a desired location, preferably a feed tank to a cuttings drying unit, for example a centrifugal cuttings drying unit, truck or disposal pit. The mobile, dual auger cuttings tank can be positioned adjacent to a drilling rig, such that the tank receives drill cuttings falling directly from the shale shaker. Use of the dual auger cuttings tank eliminates the need for an intervening device, such as a bucket scoop, to move cuttings from a tank in the area of the shaker (receiving cuttings directly from the shaker), and carry them to the feed tank for the drying unit.

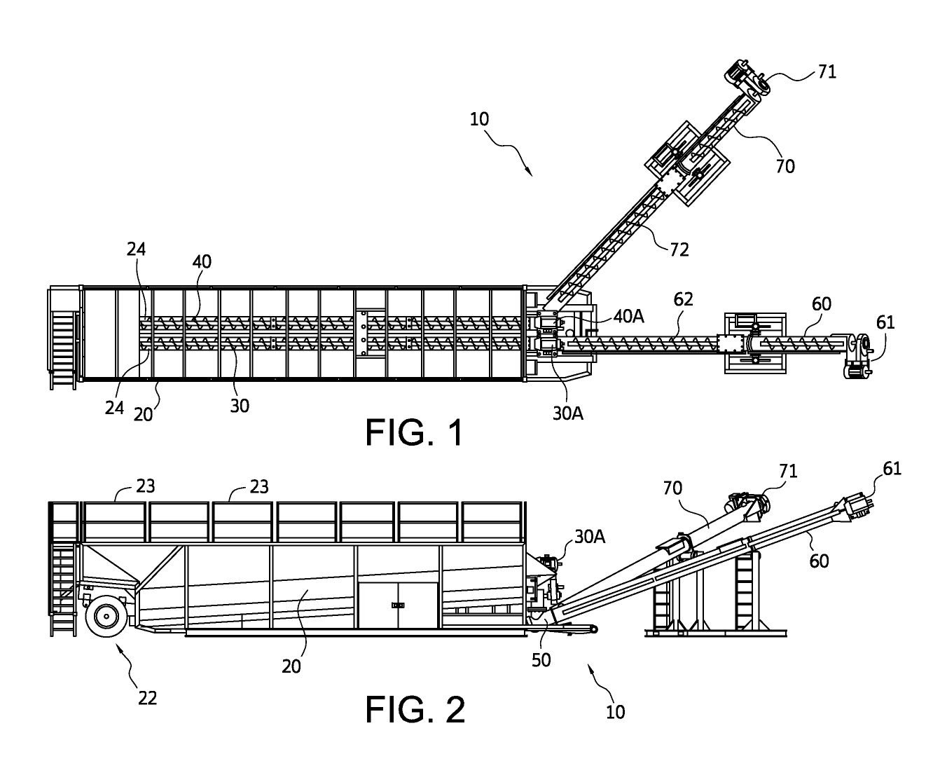

Referring to FIGS. 1 and 2, the dual feed auger tank system 10 comprises an elongated tank 20, with dimensions suitable for highway transportation. By way of example, tank 20 may have a capacity of 265 bbl, compared to a typical cuttings tank capacity of c. 65 bbl. Tank 20 may therefore accommodate a significantly higher volume of cuttings before further handling is required. Tank 20 has a wheel assembly 22 at a first end. When the opposite (second) end is lifted and attached to a tractor, tank 20 can be transported on a roadway. The bottom of tank 20, and support structure underneath, is configured such that the tank bottom slopes upwardly from the first end (typically the end nearest the wheel assembly), when tank 20 is detached from the tractor and placed on the ground, as can be seen in FIG. 2. The tank bottom and support structure, as described above, raise one end of the cuttings tank a sufficient distance that the drive units and transition section (moving cuttings from the tank augers to the boom augers) can be mounted.

As can be seen in FIG. 1, a pair of feed augers 30 and 40 are disposed in the bottom of tank 20, preferably positioned within troughs 24 running substantially the length of tank 20. Feed augers 30 and 40 are rotatable within troughs 24, as later described.

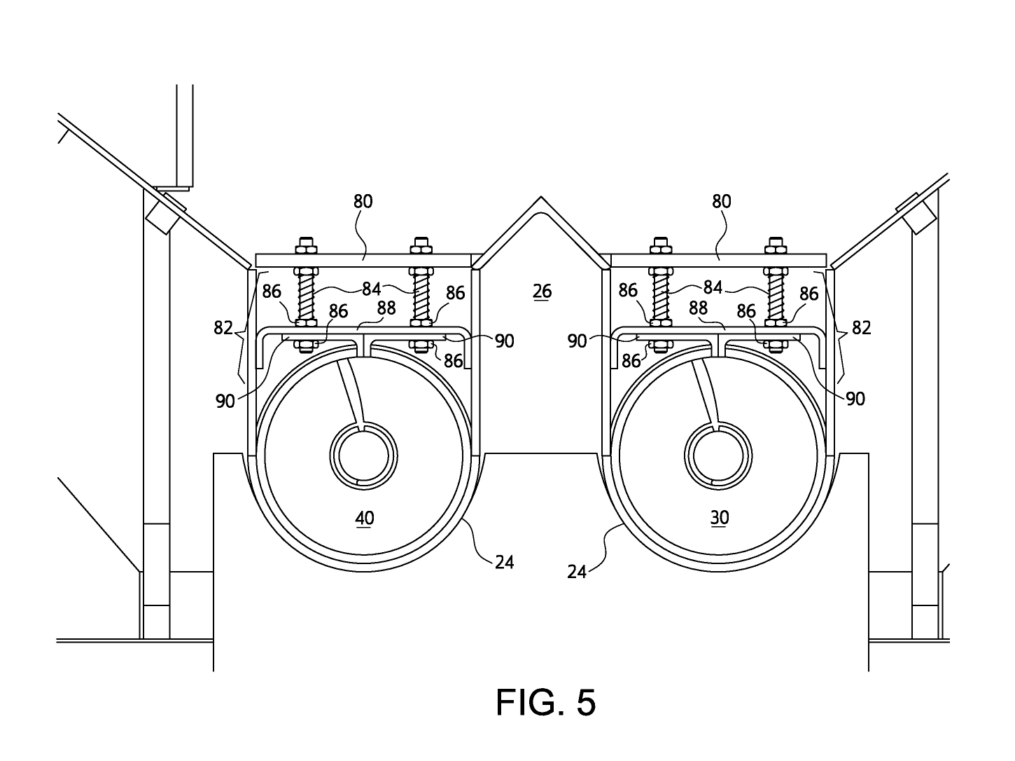

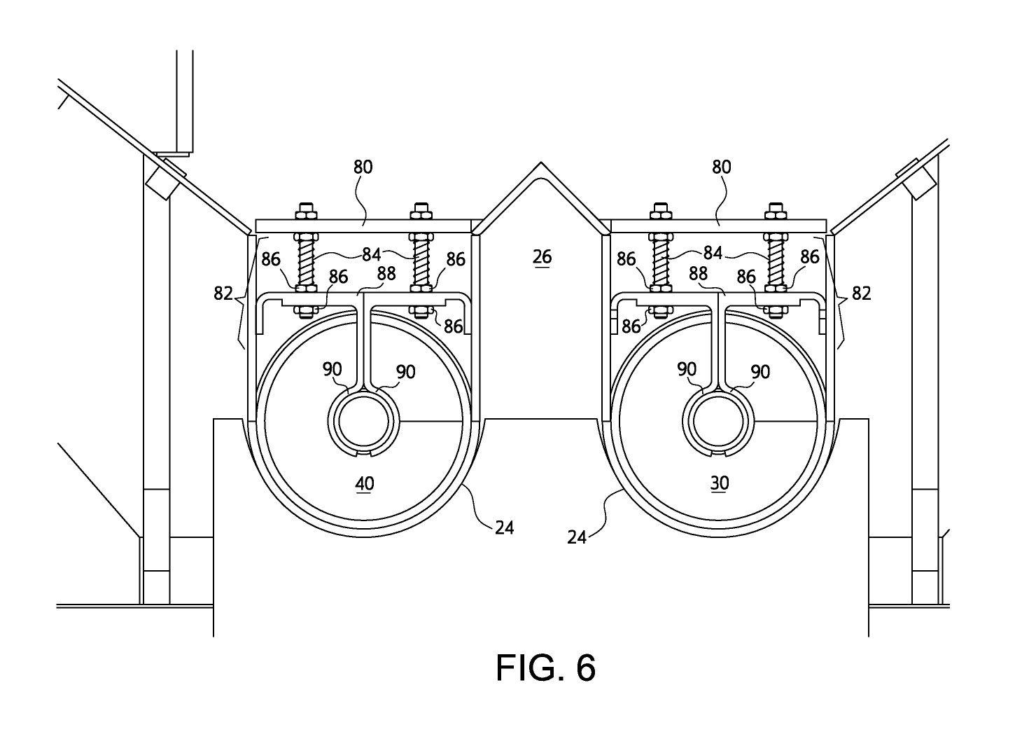

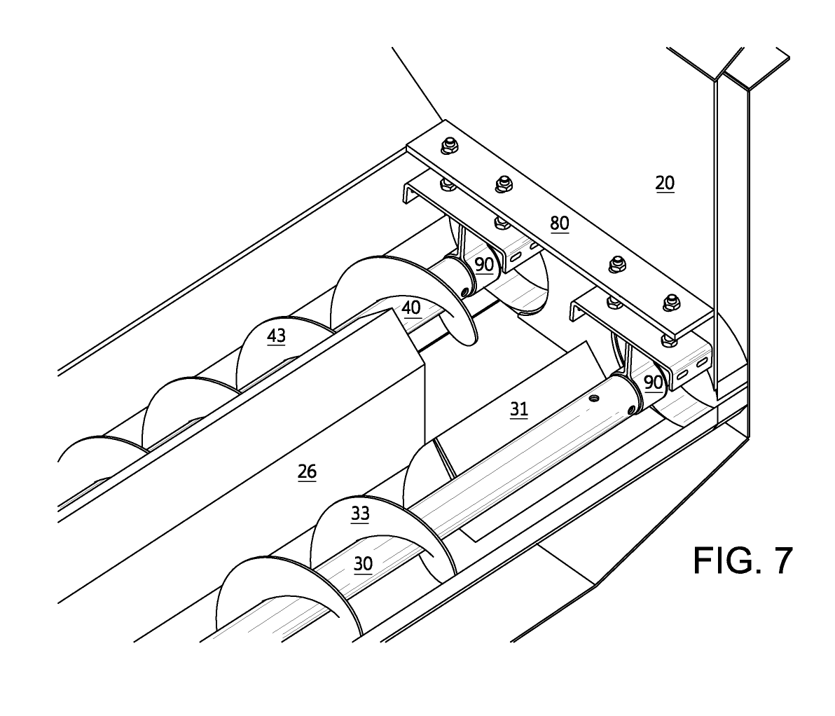

Feed augers 30 and 40 are suspended within troughs 24 by a bearing and hanger assembly, which can be seen in FIGS. 5-7. Cross pieces 80 span troughs 24, and may be held in place by welding or other suitable means. Hanger assembly 82 is connected to cross pieces 80, preferably by a means for adjusting the vertical position of hanger assembly 82. In the exemplary embodiment shown in FIGS. 5 and 6, the means for adjusting the vertical position of hanger assembly 82 comprises a plurality of threaded bolts 84 with adjusting nuts 86, which suspend adjusting plate 88. It can be appreciated that the vertical position of adjusting plate 88 may be adjusted by moving adjusting nuts 86 on threaded bolts 84.

Bearing members 90 in turn attach to adjusting plate 88 by bolting or other like means. As can be seen in FIG. 6, bearing members 90 form a split or two piece bearing, so that disassembly of bearing members 90 from adjusting plate 88 frees auger 30, 40 from the hanger assembly, and permits removal of auger 30, 40 from tank 20.

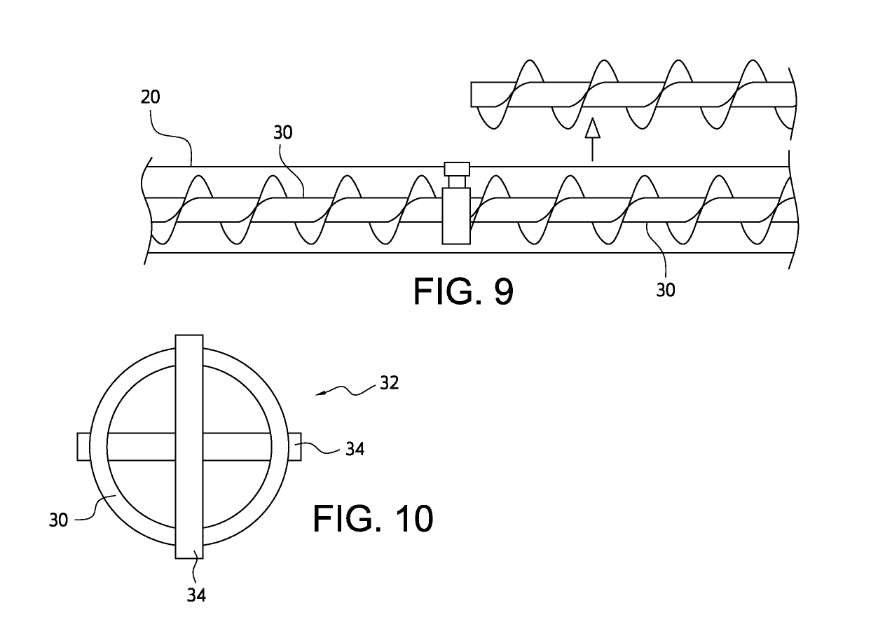

Preferably, augers 30, 40 comprise multiple sections, typically two sections, which simplify removal of augers 30, 40 from tank 20. FIG. 9 shows a preferred manner of removing augers 30, 40 from tank 20. Augers 30, 40 are in multiple sections, for example two sections. The sections of augers 30, 40 can be uncoupled, thereby yielding two sections. Rather than a single piece auger, which is very heavy and difficult to handle, and having to remove auger 30, 40 from tank 20 by moving it longitudinally out of an opening in the end of tank 20, the sections of auger 30, 40 can be tilted up and lifted generally vertically out of tank 20.

Preferably, the sections of augers 30, 40 are joined by a coupling 32, which generally comprise one member inserted inside another and bolts/pins 34 inserted therethrough which enable torque transmission through the coupling. FIG. 10 shows one possible coupling embodiment.

During use, cuttings generated in the drilling of an oil or gas well come off of a “shale shaker” and fall into tank 20. Feed augers 30 and 40 are rotated by a drive 30A and 40A (described below), moving the cuttings to one end of tank 20 (typically, a second end opposite the end where wheel assembly 20 is mounted), through a transition piece 50 (later described), and are then picked up by boom augers 62 and 72 which rotate within booms 60 and 70. It is sometimes advantageous to move cuttings laterally from one feed auger to another (sideways across tank 20). To do so, a paddle member 31 may be provided on one of feed augers 30, 40. Paddle member 31 is not spiraled as are blades 33, 43 on augers 30 and 40, but is straight and generally aligned with the longitudinal axis of auger 30. It can be appreciated that cuttings falling on paddle member 31 are not moved down auger 30 by spiral blade 33, but are moved over to the other auger 40, for movement by that auger within tank 20.

Preferably, each feed auger 30, 40 is driven (rotated) by a separate drive system, comprising a means for rotating feed augers 30, 40, shown as 30A and 40A. The separate drive systems permit the augers to be independently rotated, both as to direction of rotation and speed. While various means for rotating feed augers 30, 40 could be used to drive the augers, one preferred embodiment of means 30A, 40A comprises a variable frequency drive or “VFD” electric motor coupled to one end of each auger 30, 40. The VFD permits control of the rate of moving or feeding cuttings to the boom augers, and the resulting variable cuttings volume output permits the cuttings tank to feed cuttings to the centrifugal drying unit at an optimum rate. The VFD also permits control over the direction of movement of cuttings within tank 20, by controlling the direction of rotation of feed augers 30, 40. It is understood that other means for rotating feed augers 30, 40 are possible within the scope of the invention.

### Flanged Transition Piece Between Tank Augers and Boom Augers, Removable Booms

Cuttings are moved out of tank 20 by feed augers 30, 40, and must then be picked up by the boom augers 62, 72 to move them through and out the end of the boom 60, 70 to the desired receiving point. To move the cuttings from the feed augers to the boom augers, that is out of the tank and into the boom (to be ultimately moved to another processing equipment, for example a centrifugal cuttings drying unit), a transition section or transition piece 50 is used. Essentially, with the configuration of the augers, the cuttings are moved out of tank 20 by feed augers 30, 40 and gravity feed to the boom augers 62, 72.

Further, it is sometimes necessary to change the position of booms 60, 70 with respect to tank 20, as can be seen in FIGS. 1 and 2; these booms are generally angled upward as they go away from the cuttings tank, and extend outward a number of feet. The position of booms 60, 70 with respect to tank 20 must be changeable, i.e. rotatable around a generally vertical axis. In prior designs, where the boom is directly coupled to the cuttings tank (typically by a flanged connection), due to the weight and dimensions of the booms It is very difficult to unflange the boom from the tank, rotate it to the desired position, then re-bolt the flange.

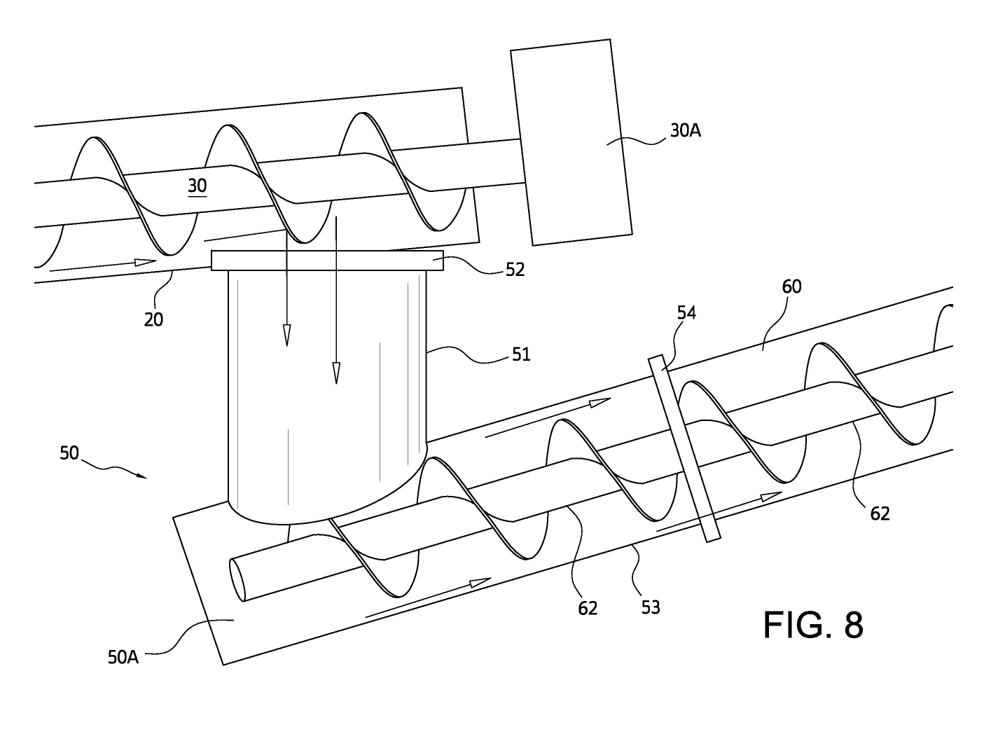

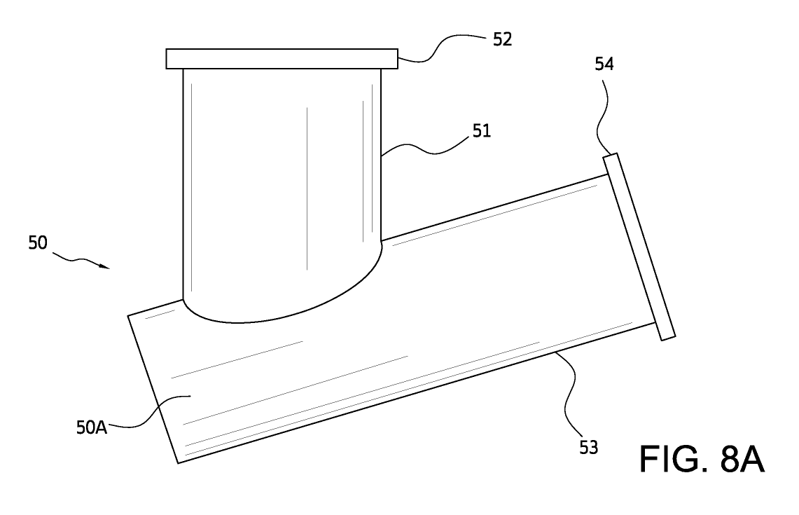

The present invention resolves this issue by a separate transition piece 50 between the tank 20 and boom 60, 70, with boom 60, 70 and boom auger 62, 72 mounting to transition piece 50 by sliding into same then bolting to a flange. It is understood that boom augers 62, 72 are driven by drive means 61, 71, which rotate boom augers 62, 72 and move cuttings through the booms. Drive means 61 and 71 may comprise fixed or variable speed electric motors, or other drive means known in the art. As can be seen in detail in FIG. 8, transition piece 50 has a vertical section 51 which couples to tank 20 by a flange 52, and an upwardly angled section 53 into which boom auger 62, 72 extends, with boom 60, 70 coupled to the upwardly angled section 53 by flange 54. A receiving chamber, generally designated as 50A, defines a space into which cuttings fall. FIG. 8A is a side view of transition piece 50 alone, detached from the remainder of the apparatus. With this design, in order to move boom 60, 70, it is disconnected from transition piece 50 and slid out of same; transition piece 50 is then unflanged from tank 20, rotated to the desired position and re-connected to tank 20; and the boom 60/boom auger 62 slid into transition piece 50 (more specifically, angled section 53) and coupled together. This arrangement avoids the difficulties in moving, aligning and holding in place a large and heavy boom and boom auger, while bolting same in place.

Yet another capability of the dual auger tank system exists. The ability to rotate feed augers 30, 40 in opposite directions enables an operator to receive cuttings on one side of tank 20 (e.g., referring to FIG. 7, on the side bearing feed auger 30), rotate feed auger 30 so as to move cuttings to the end of feed auger 30 in which paddle member 31 is placed; via paddle member 31, push cuttings across to feed auger 40; rotating feed auger 40 in the opposite direction, move cuttings down the length of feed auger 40, into its transition piece 50 and then out boom 60 or 70 as desired.

### Configuration of the Tank, Handrails, Grating, etc.

Tank 20 is configured so that it can be positioned adjacent to the shakers, with the top of tank 20 (which has a grating over same) at the same level as the mud tanks. The shale shakers discharge directly into tank 20. Handrails 23 on the top of tank 20 can be rotated into an upright position during active use, or rotated to a downward (flat) position during transport.

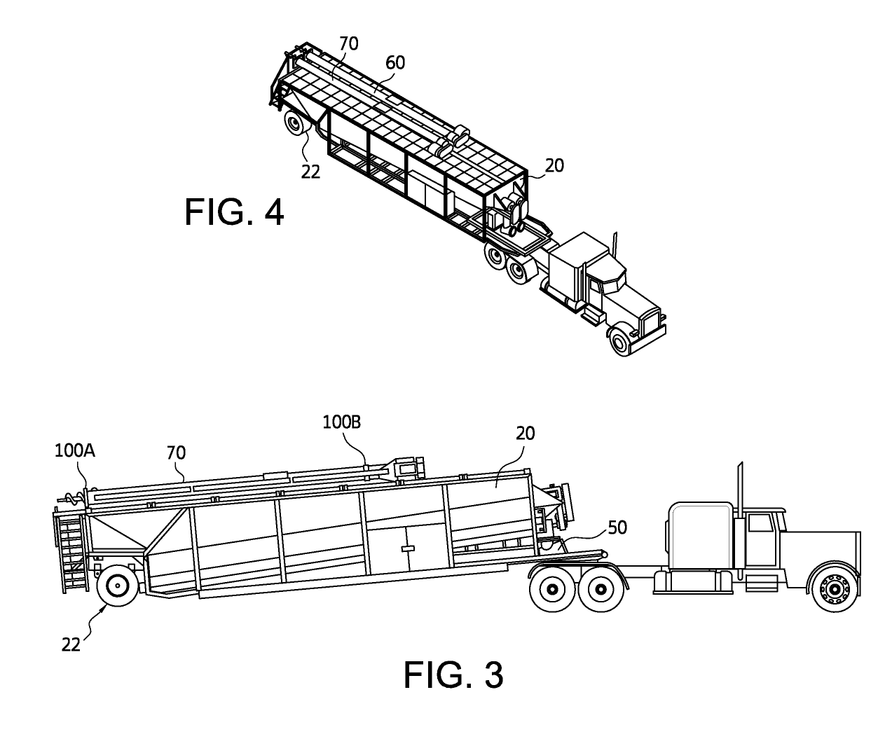

Boom storage during transportation of tank 20: as described above, booms 60, 70 are easily removable from the transition sections 50. Referring to FIGS. 3 and 4, during transportation of tank 20, booms 60, 70 are placed atop tank 20, resting in saddle members 100A and 100B. Saddle members 100A and 100B have partial circular cut-outs conforming to the size and shape of booms 60 and 70, with booms 60 and 70 placed in the cut-outs. At least one saddle member 100A is generally positioned near the wheel assembly end of tank 20, and is permanently mounted there. A hinged strap comes over the top of the booms and holds them in place. Another saddle member 100B is positioned near the other end of the booms, and can be moved out of position when the cuttings tank is in use. Suitable restraints hold that section of the booms in place. FIGS. 3 and 4 show tank 20 during transport, with booms 60 and 70 in storage position atop tank 20.

### Conclusion

While the preceding description contains many specificities, it is to be understood that same are presented only to describe some of the presently preferred embodiments of the invention, and not by way of limitation. Changes can be made to various aspects of the invention, without departing from the scope thereof. For example:
dimensions and capacities of the various components of the system can be varied to suit particular applications; and
the system can be used in cooperation with other cuttings processing equipment to fully handle cuttings discharged from a drilling rig.

Therefore, the scope of the invention is to be determined not by the illustrative examples set forth above, but by the appended claims and their legal equivalents.

We claim:

1. A cuttings tank system, comprising:
an elongated tank having a wheel assembly proximal a first end and a means for attaching said tank to a tractor for transportation on a roadway, said tank comprising a bottom angled upwardly from said first end, said bottom comprising dual troughs extending longitudinally therein;
an elongated feed auger having a spiral blade thereon, rotatably disposed in each of said troughs, each of said feed augers disposed on a means for vertically adjusting a position of said feed auger with respect to a bottom of said trough, each of said feed augers comprising a plurality of sections rotationally locked together;
a means for rotating each of said feed augers independently of the other feed auger;
a pair of transition pieces operatively connected to said tank, one of said transition pieces positioned so as to receive cuttings moved to a second end of said tank by each of said feed augers; and
at least one extended boom operably connected to one of said pair of transition pieces, said boom having a powered rotatable auger disposed therein and positioned so as to receive cuttings from said transition piece and discharge same to a desired location.

2. The cuttings tank system of claim 1, wherein said means for rotating each of said feed augers independently of the other feed auger comprises a variable frequency drive electric motor, whereby both speed of rotation and direction of rotation may be varied.

3. The cuttings tank system of claim 1, wherein said means for vertically adjusting said feed auger with respect to a bottom of said trough comprises:
a cross piece spanning said trough; and
a hanger assembly comprising a plate and split bearing assembly connected to said cross piece by a plurality of threaded rods and nuts, whereby advancing or retracting said nuts on said threaded rods moves said plate and split bearing assembly vertically with respect to said trough, said auger held within said split bearing assembly.

4. The cuttings tank system of claim 1, wherein said transition piece comprises a receiving chamber disposed below a level of said tank at said second end, a first flange attaching said transition piece to said tank, and a second flange for attaching said boom to said transition piece.

5. The cuttings tank system of claim 1, wherein at least one of said feed augers comprises a longitudinal paddle member disposed proximal one end and extending radially outward therefrom.

6. The cuttings tank system of claim 2, wherein said means for vertically adjusting said feed auger with respect to a bottom of said trough comprises:
a cross piece spanning said trough; and
a plate and split bearing assembly connected to said cross piece by a plurality of threaded rods and nuts, whereby advancing or retracting said nuts on said threaded rods moves said plate and split bearing assembly vertically with respect to said trough, said auger held within said split bearing assembly.

7. The cuttings tank system of claim 6, wherein said transition piece comprises a receiving chamber disposed below a level of said tank at said second end, a first flange attaching said transition piece to said tank, and a second flange for attaching said boom to said transition piece.

8. The cuttings tank system of claim 7, wherein at least one of said feed augers comprises a longitudinal paddle member disposed proximal one end and extending radially outward therefrom.

9. The cuttings tank system of claim 8, wherein said tank further comprises:
handrails rotatably attached to an upper portion of said tank, and movable between a first position substantially flat and a second position substantially vertical;
an open grating covering said open top of said tank; and
a plurality of saddle members disposed atop said tank and shaped to accommodate said booms when detached from said transition piece and laid therein.

10. A cuttings tank system, comprising:
an elongated tank having a wheel assembly proximal a first end and a means for attaching said tank to a tractor for transportation on a roadway, said tank comprising a bottom angled upwardly from said first end, said bottom comprising dual troughs extending longitudinally therein;
an elongated feed auger having a spiral blade thereon, rotatably disposed in each of said troughs, each of said feed augers disposed on a a cross piece spanning said trough, at least one of said feed augers comprises a longitudinal paddle member disposed proximal one end and extending radially outward therefrom;
a cross piece spanning said troughs, and a hanger assembly comprising a plate and split bearing assembly connected to said cross piece by a plurality of threaded rods and nuts, whereby advancing or retracting said nuts on said threaded rods moves said plate and split bearing assembly vertically with respect to said trough, said auger held within said split bearing assembly, so that a position of said feed auger with respect to said trough may be adjusted, each of said feed augers comprising a plurality of sections rotationally locked together;
a variable frequency drive electric motor attached to each of said feed augers, whereby both speed of rotation and direction of rotation may be varied independently of the other feed auger;
a pair of transition pieces operatively connected to said tank, one of said transition pieces positioned so as to receive cuttings moved to a second end of said tank by each of said feed augers, each of said transition pieces comprising a receiving chamber disposed below a level of said tank at said second end, a first flange attaching said transition piece to said tank, and a second flange for attaching said boom to said transition piece; and
at least one extended boom operably connected to one of said pair of transition pieces, said boom having a powered rotatable auger disposed therein and positioned so as to receive cuttings from said transition piece and discharge same to a desired location.

11. The cuttings tank system of claim 10, wherein said tank further comprises:
handrails rotatably attached to an upper portion of said tank, and movable between a first position substantially flat and a second position substantially vertical;
an open grating covering said open top of said tank; and
a plurality of saddle members disposed atop said tank and shaped to accommodate said booms when detached from said transition piece and laid therein.
